(19) United States
(12) Patent Application Publication
(10) Pub. No.: US 2006/0085204 A1
(43) Pub. Date: Apr. 20, 2006

(54) Method and system for testing information handling system components

(75) Inventor: Adolfo Sandor Montero, Austin, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/959,891

(22) Filed: Oct. 6, 2004

(51) Int. Cl. G06Q 99/00

(52) U.S. Cl. 705/1; 705/28

(57) ABSTRACT

A method and a system are provided for determining whether an information handling system (“IHS”) component is in condition for a warranty return. In response to determining that the IHS component is in condition for a warranty return and in response to an encryption algorithm, an encrypted return authorization number associated with the IHS component's identification number is determined.

### BACKGROUND

The description herein relates to testing components of an information handling systems.

As the value and use of information continue to increase, individuals and businesses seek additional ways to process and store information. One option available to users is information handling systems. An information handling system (“IHS”) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

For a manufacturer and/or seller of IHSs, reducing errors associated with accepting warranty returns of IHS components (e.g., disk drives, batteries, and graphics controller cards) is important. For example, a manufacturer and/or a seller of an IHS may accept a warranty return of a component that is specified by a customer as being in condition for a warranty return (e.g., having failed). However, in some situations, such component is ultimately determined to not have failed under the terms of a warranty. Incorrectly accepting a return of a component that has not failed under the terms of a warranty may cause various problem including financial loss to the manufacturer and/or the seller.

What is needed is a method and system for reducing errors associated with accepting warranty returns of IHS components without the disadvantages discussed above.

### SUMMARY

A method and a system are provided for determining whether an information handling system (“IHS”) component is in condition for a warranty return. In response to determining that the IHS component is in condition for a warranty return and in response to an encryption algorithm, an encrypted return authorization number associated with the IHS component's identification number is determined.

### BRIEF DESCRIPTION OF THE DRAWINGS

FIG. 1 is a block diagram of an information handling system, according to the illustrative embodiment.

FIG. 2 is a block diagram of a component, that is representative of one or more components of the IHS of FIG. 1.

FIG. 3 is a flow chart illustrating the operations of a process executed by the IHS of FIG. 1, according to the illustrative embodiment.

FIG. 4 is a flow chart illustrating the operations performed by a user of the IHS of FIG. 1 and a customer services representative, in association with a warranty return of a battery, according to the illustrative embodiment.

### DETAILED DESCRIPTION

For purposes of this disclosure, an information handling system (“IHS”) includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

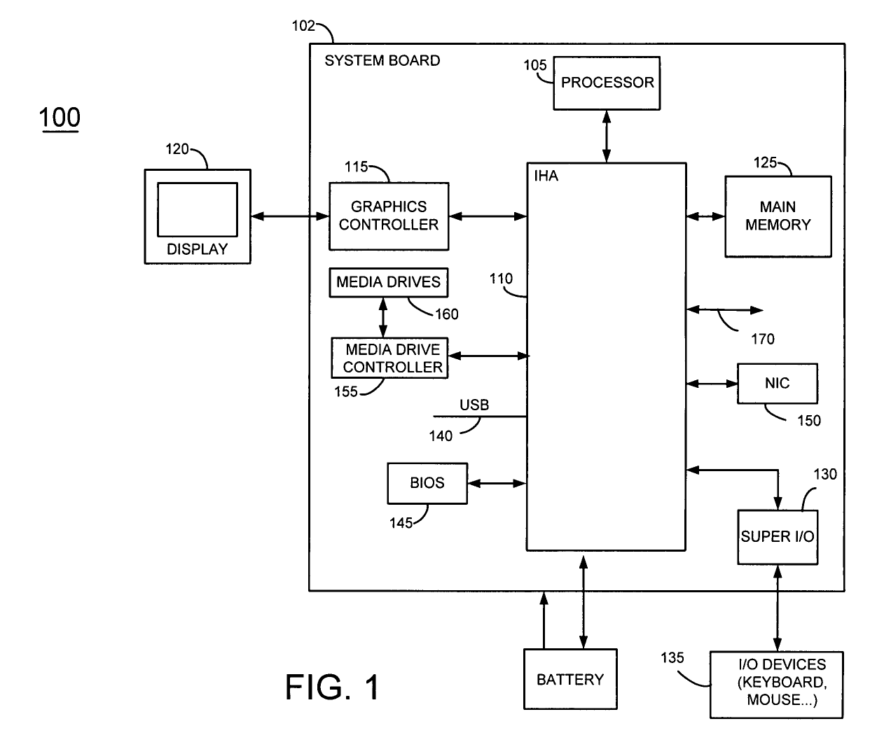

FIG. 1 is a block diagram of an information handling system (“IHS”), according to the illustrative embodiment. The IHS 100 includes a system board 102. The system board 102 includes a processor 105 such as an Intel Pentium series processor or one of many other processors currently available. An Intel Hub Architecture (IHA) chipset 110 provides the IHS system 100 with graphics/memory controller hub functions and I/O functions. More specifically, the IHA chipset 110 acts as a host controller, which communicates with a graphics controller 115 coupled thereto. A display 120 is coupled to the graphics controller 115. The chipset 110 further acts as a controller for main memory 125, which is coupled thereto. The chipset 110 also acts as an I/O controller hub (ICH), which performs I/O functions. A super input/output (I/O) controller 130 is coupled to the chipset 110 to provide communications between the chipset 110 and input devices 135 such as a mouse, keyboard, and tablet, for example. A universal serial bus (USB) 140 is coupled to the chipset 110 to facilitate the connection of peripheral devices to system 100. System basic input-output system (BIOS) 145 is coupled to the chipset 110 as shown. The BIOS 145 is stored in CMOS or FLASH memory so that it is nonvolatile.

A local area network (LAN) controller 150, alternatively called a network interface controller (NIC), is coupled to the chipset 110 to facilitate connection of the system 100 to other IHSs. Media drive controller 155 is coupled to the chipset 110 so that devices such as media drives 160 can be connected to the chipset 110 and the processor 105. Devices that can be coupled to the media drive controller 155 include CD-ROM drives, DVD drives, hard disk drives and other fixed or removable media drives. An expansion bus 170, such as a peripheral component interconnect (PCI) bus, PCI express bus, serial advanced technology attachment (SATA) bus or other bus is coupled to the chipset 110 as shown. The expansion bus 170 includes one or more expansion slots (not shown) for receiving expansion cards which provide the IHS 100 with additional functionality.

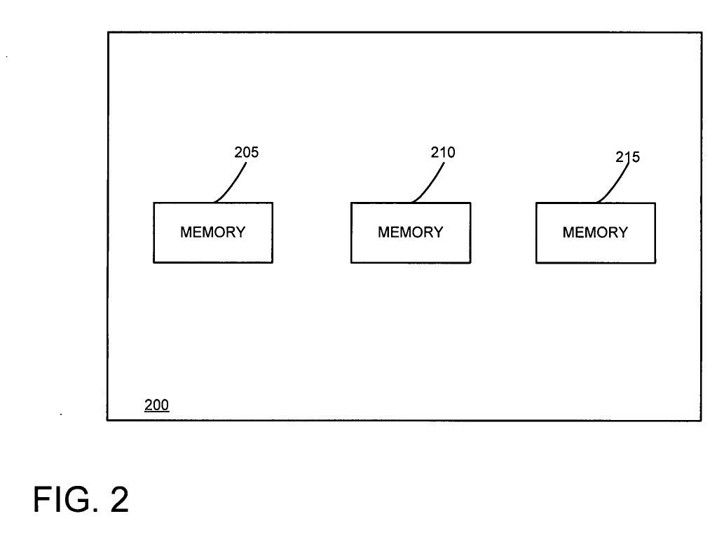

FIG. 2 is a block diagram of a component 200, that is representative of one or more components of the IHS of FIG. 1. Examples of the component 200 include a battery (e.g., the battery 175), a graphics controller (e.g., the graphics controller 115), a media drive (e.g., one of the media drives 160), and other components depicted in FIG. 1.

The component 200 includes a memory 205, a memory 210, and a memory 215. Each of the memories 205, 210, and 215 is a non-volatile memory (e.g., a register). FIG. 2 depicts the three memories 205, 210, and 215, although the component 200 may include additional or fewer memories.

In this example, the component 200 is a battery, and the following discussion references the component 200 as battery 200. Accordingly, one or more of the memories 205, 210, and 215 store various information associated with the battery's status (e.g., operation status), such as information associated with the battery's capacity according to its design, the battery's actual capacity, the battery's charge-discharge cycle count, whether the battery is able to communicate with its IHS, and/or whether the battery is in a failure mode.

As discussed above, reducing errors associated with accepting warranty returns of the battery 200 is important. Accordingly, the IHS 100 is capable of executing a process for testing whether the battery 200 is in condition for a warranty return (e.g., has failed). In one example, such process is included by a computer program product (e.g., a battery test utility program) that is executed in response to a command from the IHS 100's user.

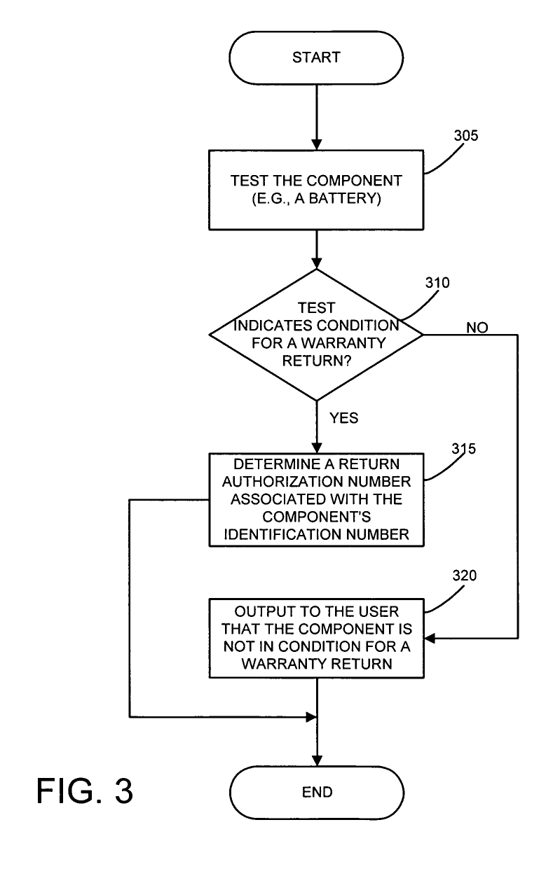

FIG. 3 is a flow chart illustrating the operations of the process executed by the IHS 100 according to the illustrative embodiment. The operation begins at a step 305 where the IHS 100 tests the battery 200 to determine whether the battery 200 is in condition for a warranty return by performing one or more of the following illustrative operations.

In a first example operation, the IHS 100 determines whether the battery 200 has failed by reading one or more of the memories 205, 210, and 215 for an indication that the battery 200 is in a failure mode. In response to reading such indication, the IHS 100 determines that the battery 200 has failed.

In a second example operation, the IHS 100 determines whether the battery 200 has failed by determining whether the battery has failed to communicate with the IHS 200 (e.g. via system management (“SM”) bus). If so, the IHS 100 determines that the battery 200 has failed.

In a third example operation, the IHS 100 determines whether the battery 200 has failed by determining whether the battery has lost more of its capacity than it was designed to lose via usage (e.g., as indicated by charge/discharge cycle count). For example, if battery 200 is designed to lose 20 percent (%) of its capacity after 300 charge/discharge cycles irrespective of time, the IHS 100 is capable of determining, for a given number charge/discharge cycle count, whether the battery has lost more of its capacity than it was designed to lose. Accordingly, in at least one embodiment, the memory 205 is a register that stores a value for the battery 200's designed capacity, the memory 210 is a register that stores the battery 200's actual capacity, and the memory 215 is a register that stores the battery 200's charge/discharge cycle count. The IHS 100 reads the battery 200's designed capacity, actual capacity, and charge/discharge cycle count from the memories 205, 210, and 215, and in response thereto, determines whether for the charge/discharge cycle, the battery 200 has lost more of its capacity than it was designed to lose. If so, the IHS 100 determines that the battery 200 has failed.

After performing one or more of the testing operations discussed above in the step 305, the operation continues to a step 310. At the step 310, the IHS 100 determines whether one or more of the testing operations performed at the step 305 indicate that the battery 200 is in condition for a warranty return (e.g., has failed). If so, the operation continues to a step 315.

At the step 315, the IHS 100 determines (e.g., generates) a return authorization number (e.g., a return merchandise authorization (“RMA”) number) associated with the battery 200's identification number (e.g., a serial number). In one example, such RMA number is generated by generating a encrypted number in response to the battery 200's serial number and an encryption/decryption algorithm.

Optionally at the step 315, the IHS 100 is capable of generating a shipping label that is suitable for use in returning the battery 200. After the step 315, the operation ends.

Referring again to the step 310, if the IHS 100 determines that none of the testing operations performed at the step 305 indicates that the battery has failed, the operation continues to a step 320. At the step 320, the IHS 100 outputs (e.g., via a display device such as the display 120) to the IHS 100's user that the component did not fail and that battery is not eligible for a warranty return. Optionally, the IHS 100 is also capable of requesting the IHS 100's user to input a user command indicating that the user wishes to place a order for a new battery to replace the battery 200. In response to receiving a command indicating as such, the IHS 100 is capable of submitting such order (e.g., via a network such as the Internet) in behalf of the user. After the step 320, the operation ends.

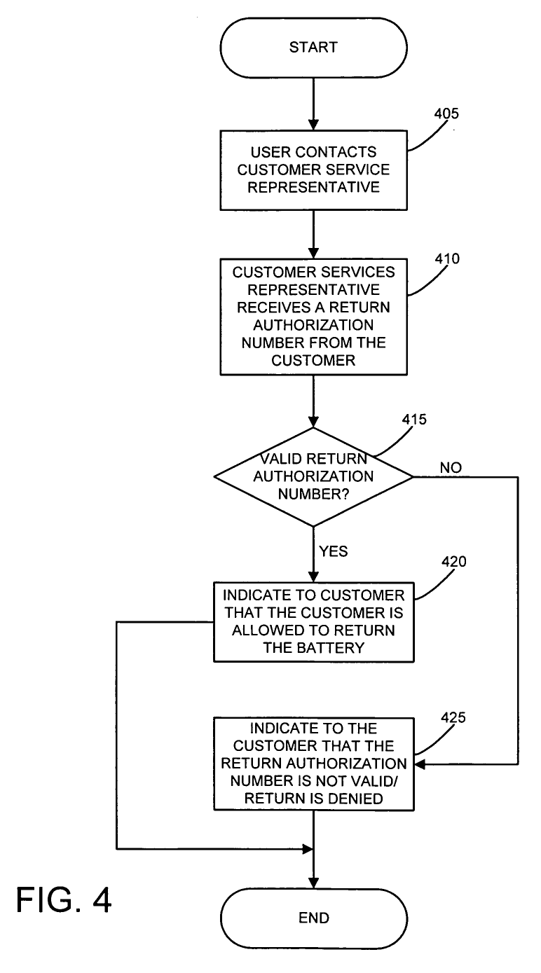

FIG. 4 is a flow chart illustrating the operations performed by the IHS 100's user and a customer services representative in association with a warranty return of the battery 200, according to the illustrative embodiment. The operation begins at a step 405, where the user contacts the customer service representative (e.g., via phone). After the step 405, the operation continues to a step 410.

At the step 410, the customer services representative receives a RMA number (e.g., a number generated at the step 315 of FIG. 3 or a number represented as such) and a serial number from the user. After the step 410, the operation continues to a step 415.

At the step 415, the customer services representative determines whether the RMA number received at the step 410 is a valid (e.g., verifiable) RMA number associated with the serial number. The customer service representative makes such determination by encrypting (e.g., via the encryption/decryption algorithm used in step 315 of FIG. 3) the serial number, and determining whether the resulting number (e.g., the actual RMA number) is substantially identical to the RMA number received from the user.

If the customer services representative determines that the RMA number received at the step 410 is valid, the operation continues to a step 420. At the step 420, the customer services representative indicates to the user that the user is allowed to return the battery 200. After the step 420, the operation ends.

Referring again to the step 415, if the customer services representative determines that the RMA number received at the step 410 is not valid (e.g., because the number was not generated by the process discussed in connection with FIG. 3) the operation continues to a step 425. At the step 425, the customer services representative denies the user's request to return the battery 200 under the warranty. After the step 425, the operation ends.

Although illustrative embodiments have been shown and described, a wide range of modification, change and substitution is contemplated in the foregoing disclosure. Also, in some instances, some features of the embodiments may be employed without a corresponding use of other features. Accordingly, it is appropriate that the appended claims be constructed broadly and in manner consistent with the scope of the embodiments disclosed herein.

What is claimed is:

1. A method comprising:
determining whether an information handling system (“IHS”) component is in condition for a warranty return; and
in response to determining that the IHS component is in condition for a warranty return and in response to an encryption algorithm, determining an encrypted return authorization number associated with the IHS component's identification number.

2. The method of claim 1, wherein the return authorization number is verifiable by a customer services representative to determine whether the IHS component is actually in condition for a warranty return.

3. The method of claim 2, wherein determining whether the IHS component is actually in condition for a warranty return includes:
receiving, from a user, a number represented to be a return authorization number associated with the IHS component's identification number;
in response to the IHS component's identification number and in response to the encryption algorithm, determining an actual return authorization number; and
determining whether the actual authorization number is substantially identical to the number represented to be the return authorization number.

4. The method of claim 1, wherein determining whether the IHS component is in condition for a warranty return includes determining whether the IHS component has failed.

5. The method of claim 1, and comprising:
in response to determining that the IHS component is not in condition for a warranty return, outputting a message indicating that the component is not in condition for a warranty return.

6. The method of claim 1, wherein the IHS component is a media drive.

7. The method of claim 1, wherein the IHS component is a battery.

8. The method of claim 7, wherein determining whether the battery is in condition for a warranty return includes:
determining whether the battery is in a failure mode.

9. The method of claim 7, wherein determining whether the battery is in condition for a warranty return includes:
determining whether the battery has failed to communicate with the IHS.

10. The method of claim 7, wherein determining whether the battery is in condition for a warranty return includes:
determining whether the battery has lost more capacity, for a given amount of usage, than it was designed to lose.

11. The method of claim 10, wherein the amount of usage is indicated by the battery's charge/discharge cycle count.

12. An information handling system (“IHS”) comprising:
a processor; and
a memory, coupled to the processor, which stores instructions executable by the IHS to cause the IHS to:
determine whether an information handling system (“IHS”) component is in condition for a warranty return; and
in response to determining that the IHS component is in condition for a warranty return and in response to an encryption algorithm, determine an encrypted return authorization number associated with the IHS component's identification number.

13. The IHS of claim 12, wherein the return authorization number is verifiable by a customer services representative to determine whether the IHS component is actually in condition for a warranty return.

14. The IHS of claim 13, wherein determining whether the IHS component is actually in condition for a warranty return includes:
receiving, from a user, a number represented to be a return authorization number associated with the IHS component's identification number;
in response to the IHS component's identification number and in response to the encryption algorithm, determining an actual return authorization number; and
determining whether the actual authorization number is substantially identical to the number represented to be the return authorization number.

15. The IHS of claim 12, wherein determining whether the IHS component is in condition for a warranty return includes determining whether the IHS component has failed.

16. The IHS of claim 12, wherein the instructions are executable by the IHS to further cause the IHS to:
in response to determining that the IHS component is not in condition for a warranty return, output a message indicating that the component is not in condition for a warranty return.

17. The IHS of claim 12, wherein the IHS component is a media drive.

18. The IHS of claim 12, wherein the IHS component is a battery.

19. The IHS of claim 18, wherein determining whether the battery is in condition for a warranty return includes:
determining whether the battery is in a failure mode.

20. The IHS of claim 18, wherein determining whether the battery is in condition for a warranty return includes:
determining whether the battery has failed to communicate with the IHS.

21. The IHS of claim 18, wherein determining whether the battery is in condition for a warranty return includes:
determining whether the battery has lost more capacity, for a given amount of usage, than it was designed to lose.

22. The IHS of claim 21, wherein the amount of usage is indicated by the battery's charge/discharge cycle count.
